(19) United States
(12) Patent Application Publication
(10) Pub. No.: US 2021/0327047 A1
(43) Pub. Date: Oct. 21, 2021

(54) LOCAL DEFECT DETERMINATIONS

(71) Applicants: Hewlett-Packard Development Company, L.P., Spring, TX (US); Purdue Research Foundation, West Lafayette, IN (US)

(72) Inventors: Jan Allebach, Boise, ID (US); Richard Eric Maggard, Boise, ID (US); Renee Jeanette Jessome, Boise, ID (US); Mark Quentin Shaw, Boise, ID (US); Qiulin Chen, West Layfayette, IN (US)

(73) Assignees: Hewlett-Packard Development Company, L.P., Spring, TX (US); Purdue Research Foundation, West Lafayette, IN (US)

(21) Appl. No.: 17/257,873

(22) PCT Filed: Jan. 11, 2019
(86) PCT No.: PCT/US2019/013144

§ 371 Date: Jan. 5, 2021

(51) Int. Cl. G06T 7/00; G06N 20/10; G06K 9/62; G06K 9/46

(52) U.S. Cl. CPC G06T 7/0004; G06K 9/469; G06K 9/6269; G06N 20/10

(57) ABSTRACT

An example of an apparatus is provided. The apparatus includes a communication interface to receive an image of output from a printing device. The apparatus further includes a memory storage unit connected to the communication interface. The memory storage unit is to store the image of the output. The apparatus also includes a preprocessing engine to process the image. In addition, the apparatus includes a selective search engine to define a search area within the image. The selective search engine defines the search area of the image based on a local defect of unknown size. Furthermore, the apparatus includes a classification engine in communication with the selective search engine. The classification engine is to classify the search area for identification of the local defect.

### BACKGROUND

A printing device may generate prints during operation. In some cases, the printing device may introduce defects into the output which is not present in the original image provided to the printing device. The defects may include a discoloration or a spot that appears on the output of the printing device. The defects may be an indication of a hardware failure or a direct result of the hardware failure. In some cases, the defects may be identified with a side by side comparison of the intended image with the print generated from the image file.

### BRIEF DESCRIPTION OF THE DRAWINGS

Reference will now be made, by way of example only, to the accompanying drawings in which:

FIG. 1 is a block diagram of an example apparatus to detect and identify local defects on output from a printing device;

FIG. 2A is a montage of local defects resized into a uniform patch size;

FIG. 2B is a montage of the result of applying a Nasanen filter to the montage of FIG. 2A;

FIG. 3 is a block diagram of an example system to detect and identify local defects on output from a printing device;

FIG. 4 is a block diagram of another example apparatus to detect and identify local defects on output from a printing device;

FIG. 5 is a block diagram of another example apparatus to detect and identify local defects on output from a printing device;

FIG. 6 is a flowchart of an example method of detecting and identifying local defects on output from a printing device; and

FIG. 7A is representation of a first layer of a pyramid representation;

FIG. 7B is representation of a second layer of a pyramid representation; and

FIG. 7C is representation of a third layer of a pyramid representation.

### DETAILED DESCRIPTION

Although there may be a trend to paperless technology in applications where printed media has been the standard, such as electronically stored documents in a business, printed documents are still widely accepted and may often be more convenient to use. In particular, printed documents are easy to distribute, store, and be used as a medium for disseminating information. In addition, printed documents may serve as contingency for electronically stored documents, such as may happen when an electronic device fails, such as with a poor data connection for downloading the document and/or a depleted power source. Accordingly, the quality of printed documents is to be assessed to maintain the integrity of the information presented in the printed document as well as to maintain aesthetic appearances.

For example, printing devices may generate artifacts that degrade the quality of printed documents. These artifacts may occur, for example, due to defective toner cartridges and general hardware malfunction. In general, numerous test pages are printed to check for defects both during manufacturing and while a printing device is in use over the life of the printing device. Visually inspecting each printed document by a user may be tedious, time consuming, and error prone. This disclosure includes examples that provide an automated method to detect local artifacts in printed pages, without using defect-free images for comparison purposes.

An apparatus is provided to carry out automated computer vision-based method to detect and locate printing defects in scanned images is provided. In particular, the apparatus carries out the method without comparing a printed document against a reference source image to reduce the amount resources used to make such a comparison. By omitting the comparison with a reference source image, the method used by the apparatus reduces the resources that are to be used to integrate a reference comparison process into a printing workflow. As an example, the apparatus may be used to detect spots or discolorations on printed documents using a machine learning model, such as a support vector machine model. In order to detect the local defects, a pyramid representation where subsequent image layers are smoothed or filtered, such as a Gaussian pyramid, may be used.

In other examples, the apparatus may also carry out an analysis on image differences where the input data may be the difference between the scanned image and a reference image.

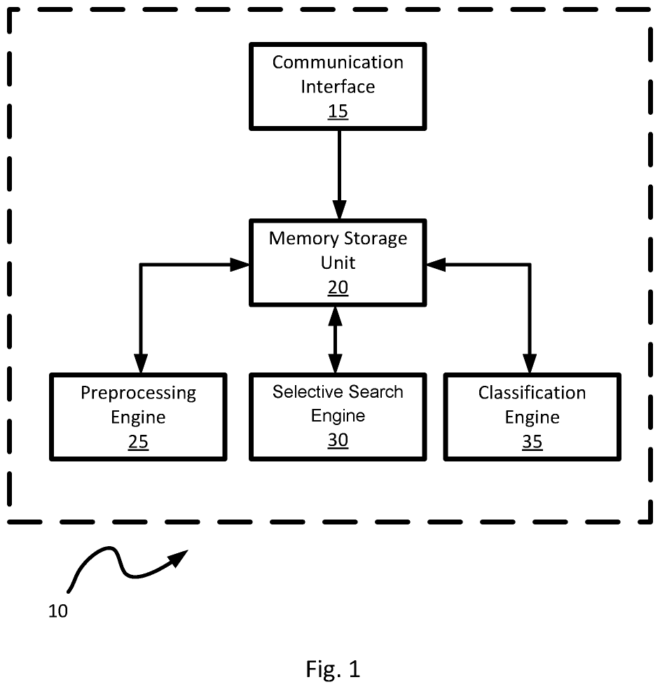

Referring to FIG. 1, an example of an apparatus for detecting and identifying local defects on output from a printing device is generally shown at 10. The apparatus 10 may include additional components, such as various memory storage units, additional interfaces to communicate with other devices over various network connections, and further input and output devices to interact with a user or an administrator of the apparatus 10. In addition, input and output peripherals may be used to train or configure the apparatus 10 as described in greater detail below. In the present example, the apparatus 10 includes a communication interface 15, a memory storage unit 20, a preprocessing engine 25, a selective search engine 30, and a classification engine 35.

Each of the preprocessing engine 25, the selective search engine 30, and the classification engine 35 may be separate components such as separate microprocessors in communication with each other within the same computing device. In other examples, the preprocessing engine 25, the selective search engine 30, and the classification engine 35 may be separate self-contained computing devices communicating with each other over a network where each engine is designed to carry out a specific function. Although the present example shows the preprocessing engine 25, the selective search engine 30, and the classification engine 35 as separate physical components, in other examples the preprocessing engine 25, the selective search engine 30, and the classification engine 35 may be part of the same physical component such as a microprocessor configured to carry out multiple functions. In such an example, each engine may be used to define a piece of software used to carry out a specific function.

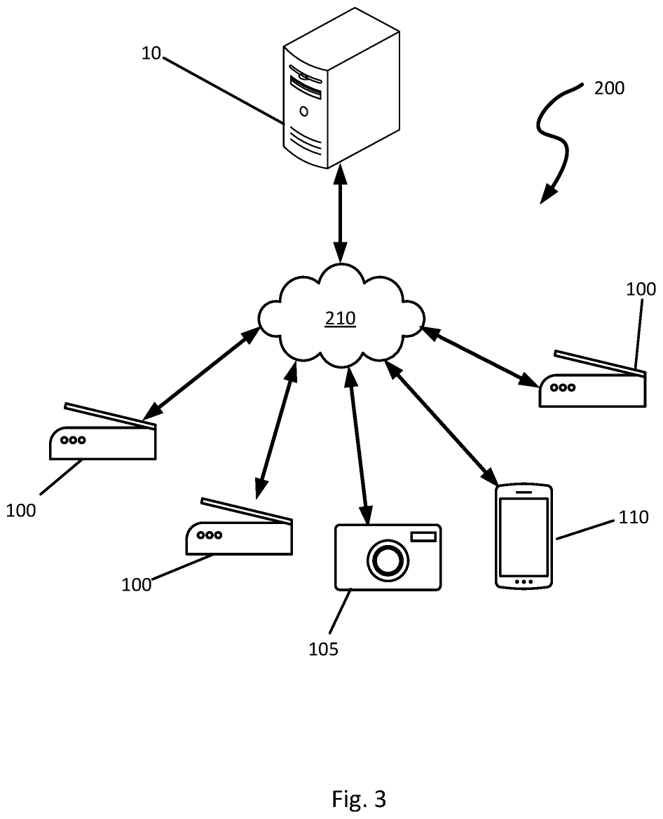

In the present example, the communication interface 15 is to receive an image of output from a printing device. Accordingly, in some examples, such as the example shown in FIG. 3, the communication interface 15 may be to communicate with external devices over the network 210, such as scanners 100, cameras 105, and smartphones 110. In this example, the communication interface 15 may be to receive an input image from the external device, such as a scanner 100, a camera 105, or a smartphone 110, where the input image is a capture of the physical output generated by the printing device. The manner by which the communication interface 15 receives the input image is not particularly limited. In the present example, the apparatus 10 may be a cloud server located at a distant location from the external devices, such as scanners 100, cameras 105, and smartphones 110, which may be broadly distributed over a large geographic area. Accordingly, the communication interface 15 may be a network interface communicating over the Internet. In other examples, the communication interface 15 may connect to the external devices via a peer to peer connection, such as over a wire or private network. Therefore, this feature may allow the apparatus 10 to connect to external devices capable of capturing images of output from printing devices at various locations, such as to manage a plurality of printing devices.

The memory storage unit 20 is in communication with the communication interface 15 to receive and to store the input image to be assessed for local defects. In addition, the memory storage unit 20 may maintain other data, such as train data for the machine learning model as well as interim images generated at various stages of the analysis to detect and identify local defects.

In the present example, the preprocessing engine 25 is to preprocess the image of output from a printing device. In particular, the preprocessing engine 25 is to preprocess the input image in preparation of for the selective search engine. For example, the preprocessing engine 25 may be to decrease the resolution of the input image such that it may be subsequently processed by the selective search engine 30 and the classification engine 35 within a reasonable amount of time. Therefore, the resolution of the input image may be limited by the processing and memory capacity of the apparatus 10.

Furthermore, the preprocessing engine 25 may be to reduce halftone effects in the image of the output from the printing device. Halftone effects may inherently arise when a digital image is captured on a camera. For example, to achieve the appearance of continuous tone imagery, the digital image may use dots that vary in either spacing or size to provide a gradient-like effect of ca continuous tone. The manner by which the halftone effects in the image of the output from the printing device is reduced is not particularly limited. For example, the halftone effects may be reduced by applying a descreening filter on the input image of the output from the printing device. In the present example, a low pass filter, such as a Nasanen filter, may be used to smooth the input image. Accordingly, a preprocessed image where the halftone effects are reduced may be generated by the preprocessing engine 25 to provide a more accurate representation as seen by a person than the originally received input image captured by an external device.

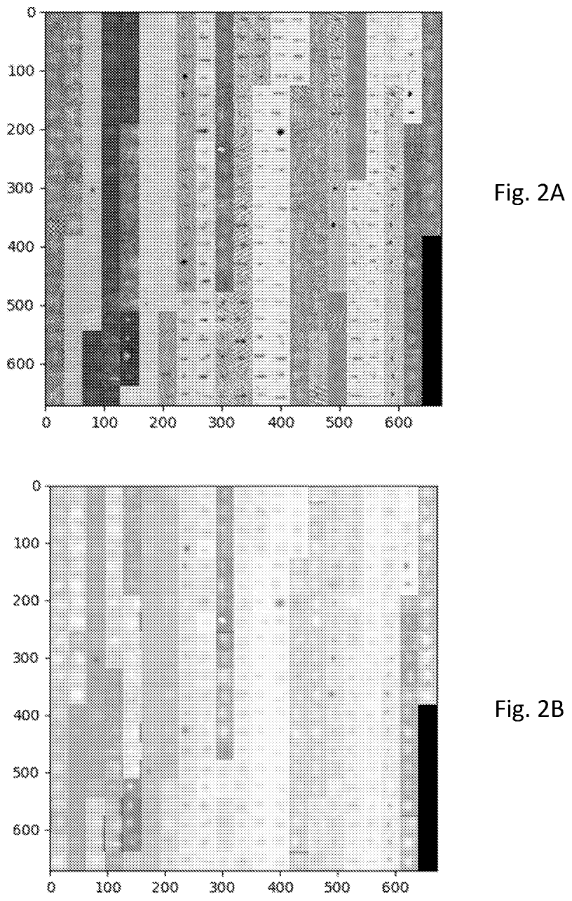

Referring to FIG. 2A and FIG. 2B, an example of an application of the preprocessing engine 25 is shown. In this example, a montage of local defects resized into a patch 32×32 pixels are combined to form an input image (FIG. 2A) to be fed into the preprocessing engine 25. After applying the Nasanen filter, the preprocessed image (FIG. 2B) is generated. By comparing FIG. 2A and FIG. 2B, it is apparent that the local defects on each of the patches is smoothed.

The selective search engine 30 is to define a search area within the input image of the output from the printing device. In the present example, the selective search engine 30 may define a search area of any size based on the on a detected local defect that may be an unknown size relative to the entire input image. For example, the local defect may occupy five percent of the total area of the input image. In this example, the search area may be defined as a small box encompassing the expected local defect. In other examples, the local defect may occupy fifty percent of the total area of the input image. In this example with the larger local defect, the search area may be defined as a large box encompassing a substantial portion of the input image.

In the present example, the selective search engine 30 may use a pyramid representation having multiple levels to identify a region of interest. In particular, a Gaussian pyramid representation may be used where each level is weighed using a Gaussian average of adjacent pixels from a previous level. Accordingly, with each subsequent level, the image may be reduced in size. Therefore, each of multiple levels of images may be generated where each subsequent level is reduced in size due to the averaging. In some examples, the selective search engine 30 may upsample the images of each level to maintain the overall size, such as the resolution, of the images across multiple levels to facilitate comparison defined search areas across levels as discussed below.

In the present example, the selective search engine 30 applies a graph-based segmentation method to each of the levels in the pyramid representation. For example, if a three level Gaussian pyramid representation is used, the graph-based segmentation method is to be applied to the image in each of the three levels of the pyramid. At each level, a selective search engine 30 may identify potential regions of interest in the respective image. The identified potential regions of interest in the images may then be compared across all levels of the pyramid to define a search area within the input image for subsequent processing by the classification engine 35. Although the present example is illustrated with a three level Gaussian pyramid representation, it is to be appreciates that more or fewer levels may be used by the selective search engine 30.

The manner by which the search area is ultimately defined based on the multiple levels is not particularly limited. For example, the search area may be defined for each region of interest in any level of the pyramid representation is identified. Under these conditions, it is to be appreciated that any regions missed on one level may be caught at a different level and sent to the classification engine 35 for further processing. However, this may also generate a large number of search areas for subsequent processing by the classification engine 35.

In another example, the search area may be defined for regions of interest with significant overlap among at least two of the three levels in the pyramid. Significant overlap may mean substantially identical regions of interest or if the overlap is above a predetermined threshold, such as 95%, 90%, or 85%. Under these conditions, it is to be appreciated that any regions of interest missed on one level may be caught at a different level and sent to the classification engine 35 for further processing. By using a correlation between two levels, regions of interest identified by the selective search engine 30 on a single level may be excluded and therefore may reduce the number of false positives to be sent to the classification engine 35 and thus reduce the computational resources to classify the defined search areas.

In yet another example, the search area may be defined for regions of interest with significant overlap unanimously across all three levels in the pyramid. Significant overlap may mean substantially identical regions of interest or if the overlap is above a predetermined threshold, such as 95%, 90%, or 85%. By using a unanimous correlation across all levels, regions of interested identified by the selective search engine 30 not identified on a level may be excluded and therefore may reduce the number of false positives to be sent to the classification engine 35 even further. Therefore, this may reduce the computational resources to classify the defined search areas.

The classification engine 35 is to receive a defined search area from the selective search engine 30. The manner by which the classification engine 35 receives the defined search area is not particularly limited. For example, the classification engine 35 may be in direct communication with the selective search engine 30 and receive a defined search area for subsequent processing. In other examples, the selective search engine 30 may write information pertaining to the defined search areas identified to the memory storage unit 20, where the classification engine may retrieve the defined search areas.

The classification engine 35 is also to classify each search area defined by the selective search engine to identify a local defect within the search area or to confirm that no defect is present in the search area. In the present example, the classification engine 35 provides a binary classification of whether there is a local defect within the defined search area or if there is no local defect within the defined search area. In other examples, the classification engine 35 may provide more results and potentially identify a cause of the local defect if present.

The manner by which the classification engine 35 operates to classify the is not particularly limited. In the present example, the classification engine 35 may use machine learning models to determine if a local defect is present within a defined search area of the input image. For example, the prediction model may be a support vector machine model or other classifier models such as random forest trees, Naïve Bayes classifiers. In other examples, the classification engine 35 may also use neural networks, such as convolutional neural networks, or recurrent neural networks. In other examples, a rules-based prediction method to analyze the defined search area of the input image may be used.

Referring to FIG. 3, an example of a print quality assessment system to detect and identify local defects on output from a printing device is generally shown at 200. In the present example, the apparatus 10 is in communication with scanners 100, a camera 105, and a smartphone 110 via a network 210. It is to be appreciated that the scanners 100, the camera 105, and the smartphone 110 are not limited and additional devices capable of capturing an image may be added.

It is to be appreciated that in the system 200, the apparatus 10 may be a server centrally located. The apparatus 10 may be connected to remote devices such as scanners 100, cameras 105, and smartphones 110 to provide print quality assessments to remote locations. For example, the apparatus 10 may be located at a corporate headquarters or at a company providing a device as a service offering to clients at various locations. Users or administrators at each location periodically submit a scanned image of a printed document generated by a local printing device to determine whether the local printing device is performing within specifications and/or whether the local printing device is to be serviced.

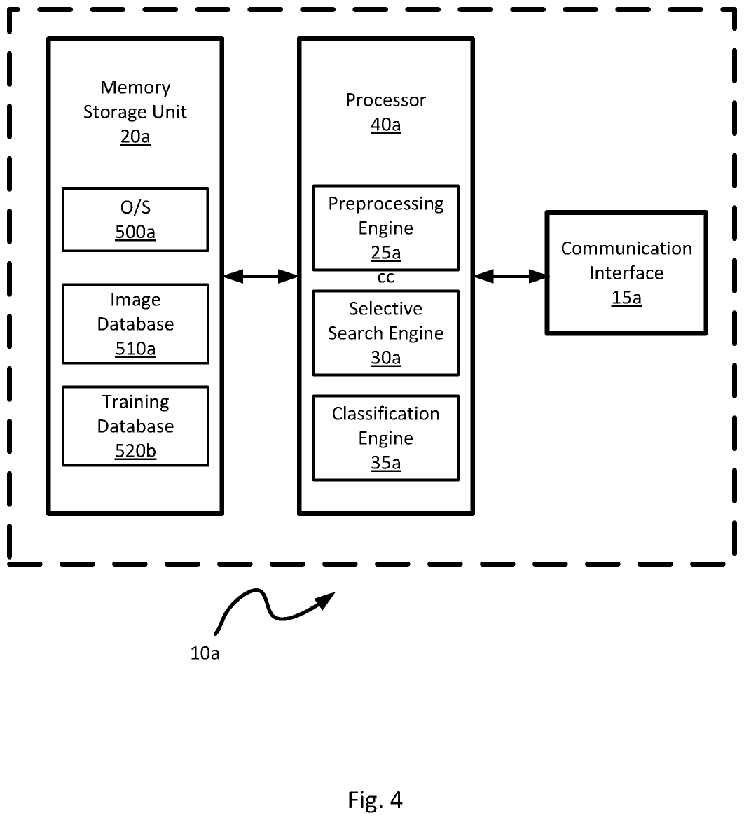

Referring to FIG. 4, another example of an apparatus for detecting and identifying local defects on output from a printing device is shown at 10a. Like components of the apparatus 10a bear like reference to their counterparts in the apparatus 10, except followed by the suffix “a”. The apparatus 10a includes a communication interface 15a, a memory storage unit 20a, and a processor 40a. In the present example, a preprocessing engine 25a, a selective search engine 30a, and a classification engine 35a are implemented by processor 40a. It is to be appreciated that the apparatus 10a may be a substitute for the apparatus 10 in the system 200. Accordingly, the following discussion of apparatus 10a may lead to a further understanding of the system 200.

The memory storage unit 20a is in communication with the communication interface 15 to receive and to store the input image to be assessed for local defects. In addition, the memory storage unit 20a is to maintain an image database 510a to store images, such as input images, preprocessed images, and images generated by the selective search engine 30a. The memory storage unit 20a may also a training database 520a to store a training dataset for the classification engine 35a. The manner by which the memory storage unit 35a stores or maintains the databases 510a and 520a is not particularly limited. In the present example, the memory storage unit 20a may maintain records in the image database 510a where each record includes multiple images associated with an input image. The memory storage unit 20a may also maintain a table in the training database 520a to store and index the training dataset received by the communication interface 15a. For example, the training dataset may include samples of test images with local defects injected into the test images. The test images in the training dataset may then be used to train the model used by the classification engine 35a. Since local defects may vary in size, the size of the test images stored in the training database 520a.

In the present example, the memory storage unit 20a may include a non-transitory machine-readable storage medium that may be, for example, an electronic, magnetic, optical, or other physical storage device. In addition, the memory storage unit 20a may store an operating system 500a that is executable by the processor 40a to provide general functionality to the apparatus 10a. For example, the operating system may provide functionality to additional applications. Examples of operating systems include Windows™, macOS™, iOS™, Android™, Linux™, and Unix™. The memory storage unit 20a may additionally store instructions to operate at the driver level as well as other hardware drivers to communicate with other components and peripheral devices of the apparatus 10a.

The processor 40a may include a central processing unit (CPU), a graphics processing unit (GPU), a microcontroller, a microprocessor, a processing core, a field-programmable gate array (FPGA), an application-specific integrated circuit (ASIC), or similar. As previously discussed, the processor 40a and the memory storage unit 20a may cooperate to execute various instructions. In the present example, the processor 40a may execute instructions stored on the memory storage unit 20a to carry out processes such as to detect and identify local defects on output from a printing device. In other examples, the processor 40a may execute instructions stored on the memory storage unit 20a to implement the preprocessing engine 25a, the selective search engine 30a, and the classification engine 35a. In other examples, the preprocessing engine 25a, the selective search engine 30a, and the classification engine 35a may each be executed on a separate processor (not shown). In further examples, the preprocessing engine 25a, the selective search engine 30a, and the classification engine 35a may each be executed on a separate machine, such as from a software as a service provider or in a virtual cloud server.

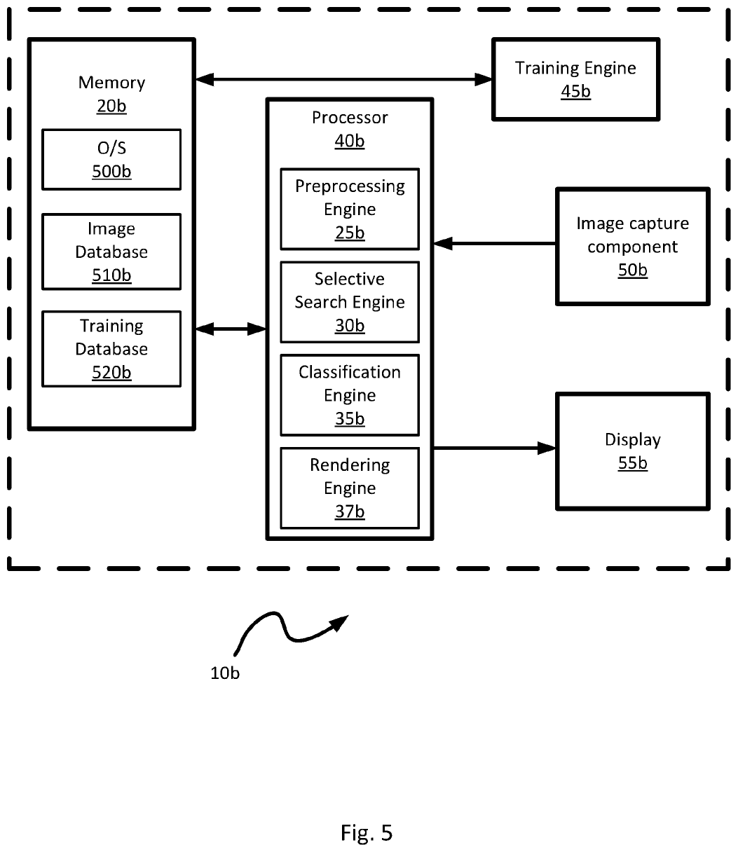

Referring to FIG. 5, another example of an apparatus to detect and identify local defects on output from a printing device is shown at 10b. Like components of the apparatus 10b bear like reference to their counterparts in the apparatus 10 and the apparatus 10a, except followed by the suffix “b”. The apparatus 10b includes a communication interface 15b, a memory storage unit 20b, a processor 40b, a training engine 45b, an image capture component 50b, and a display 55b. In the present example, a preprocessing engine 25b, a selective search engine 30b, a classification engine 35b, and a rendering engine 37b are implemented by processor 40b.

In the present example, the training engine 45b is to train a support vector machine model used by the classification engine 35b. The manner by which the training engine 45b trains the support vector machine model used by the classification engine 35b is not limited. In the present example, the training engine 45b may use images stored in the training database 520b to train the support vector machine model. For example, the training database 520b may include about 7000 images with varying dimensions and aspect ratios for training purposes and about 1800 images for testing. Specifically, in the present example, applying the support vector machine model trained with 7374 test images to 1844 test images, the accuracy of the model used by the classification engine 35b was determined to be about 92%.

In addition, common data augmentation techniques may be applied by the training engine 45b to the training images to increase their variability and increase the robustness of the support vector machine model to classify different types of local defects. For example, adding different levels of blur may help the support vector machine model handle lower resolution of input images or input images with imperfections arising from the image capture phase as opposed to the generation of the output from the printing device. Another example is adding different amounts and types of statistical noise, which may help the support vector machine model handle noisy input images. In addition, horizontal flipping may substantially double the number of training examples. It is to be appreciated that various combinations of these techniques may be applied, resulting in a training set many times larger than the original number of images.

The image capture component 50b is to capture the input image of output from a printing device. In particular, the image capture component 50b is to capture the complete image of the output from a printing device for analysis. The manner by which the image is captured using the image capture component 50b is not limited. For example, the image capture component 50b may be a flatbed scanner, a camera, a tablet device, or a handheld device connected to the apparatus 10b.

The display 55b is to output the results of the classification engine 35b. The manner by which a local defect is displayed on the display 55b is not limited. For example, the rendering engine 37b may generate an augmented image to a local defect not visible to a human eye to highlight the defect that may affect output quality. In further examples, the rendering engine 37b may superimpose pixels in various colors on the display 55b based on a type of defect to effectively color code the presentation to allow a user to readily identify where the defects are occurring as well as what type of defect is presented when the classification engine 35b may classify defect types instead of providing a binary response to whether a defect is present.

Accordingly, it is to be appreciated that the apparatus 10b may provide a single device that may be used to detect and identify local defects on output from a printing device. In particular, since the apparatus 10b includes an image capture component 50b and a display 55b, it may be put into a portable handheld device to allow for rapid local assessments of print quality. For example, the apparatus 10b may also be implemented in a smartphone using existing infrastructure such as the camera as the image capture component 50b.

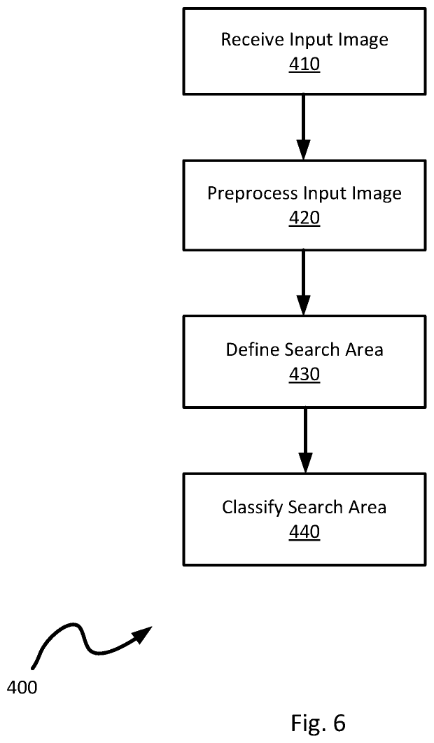

Referring to FIG. 6, a flowchart of an example method of detecting and identifying local defects on output from a printing device is generally shown at 400. In order to assist in the explanation of method 400, it will be assumed that method 400 may be performed with the system 200. Indeed, the method 400 may be one way in which system 200 along with an apparatus 10 may be configured. Furthermore, the following discussion of method 400 may lead to a further understanding of the system 200 and the apparatus 10. In addition, it is to be emphasized, that method 400 may not be performed in the exact sequence as shown, and various blocks may be performed in parallel rather than in sequence, or in a different sequence altogether.

Beginning at block 410, an input image of output from a printing device, such as a printed test page, is received. The manner by which the input image is received is not particularly limited. For example, the input image maybe captured by an external device at a separate location. For example, the input image may then be transmitted from the external device, such as a scanner 100, a camera 105, or a smartphone 110, to the apparatus 10 via the network 210 for additional processing.

Block 420 uses the preprocessing engine 15 to preprocess the input image received at block 410 to generate a preprocessed image. In the present example, the input image is to be descreened to reduce halftone effects in the input image. The manner by which the preprocessing engine 15 reduces the halftone effects in the image of the output from the printing device is not particularly limited. For example, the halftone effects may be reduced by applying a descreening filter on the input image to generate the preprocessed image. In the present example, a low pass filter, such as a Nasanen filter, may be used to smooth the input image. Accordingly, the preprocessed image where the halftone effects are reduced may be generated by the preprocessing engine 25 to provide a more accurate representation as seen by a person than the originally received input image captured by an external device. Once the preprocessed image is generated, the preprocessed image may be stored on the memory storage unit 20 or in a database such as the image database 510a to be associated with the input image received at block 410.

Block 430 involves defining a search area within the preprocessed image based on a local defect of an unknown size. The manner by which search areas are defined is not particularly limited and may us various methods to identify a region of interest where a local defect may be present. In the present example, a pyramid representation having multiple levels to identify regions of interest is used. In particular, a Gaussian pyramid representation may be used to generate multiple levels of images. In the present example, the images generated for the Gaussian pyramid representation may be stored in the memory storage unit 20, such as in the image database 510a to be associated with the input image received at block 410.

In a pyramid representation of the preprocessed image, each subsequent level may have an image that is reduced in size. Therefore, each of multiple levels of images may be generated where each subsequent level is reduced in size due to the averaging. In the present examples, the subsequent images of each level may be upsampled to maintain the overall size, such as the resolution, of the images across multiple levels to facilitate comparison defined search areas across levels as discussed below.

In the present example, a graph-based segmentation method is applied to each of the levels in the pyramid representation. For example, if a three level Gaussian pyramid representation is used, the graph-based segmentation method is to be applied to the image in each of the three levels of the pyramid. At each level, potential regions of interest may be identified in the image of the pyramid representation. The identified potential regions of interest in the images may then be compared across all levels of the pyramid to define a search area within the input image for subsequent processing by the classification engine 35. Although the present example is illustrated with a three level Gaussian pyramid representation, it is to be appreciates that more or fewer levels may be used by the selective search engine 30.

The manner by which the search area is ultimately defined based on the multiple levels is not particularly limited. For example, the search area may be defined for each region of interest in any level of the pyramid representation is identified. Under these conditions, it is to be appreciated that any regions missed on one level may be caught at a different level. However, this may also generate a large number of search areas for subsequent processing.

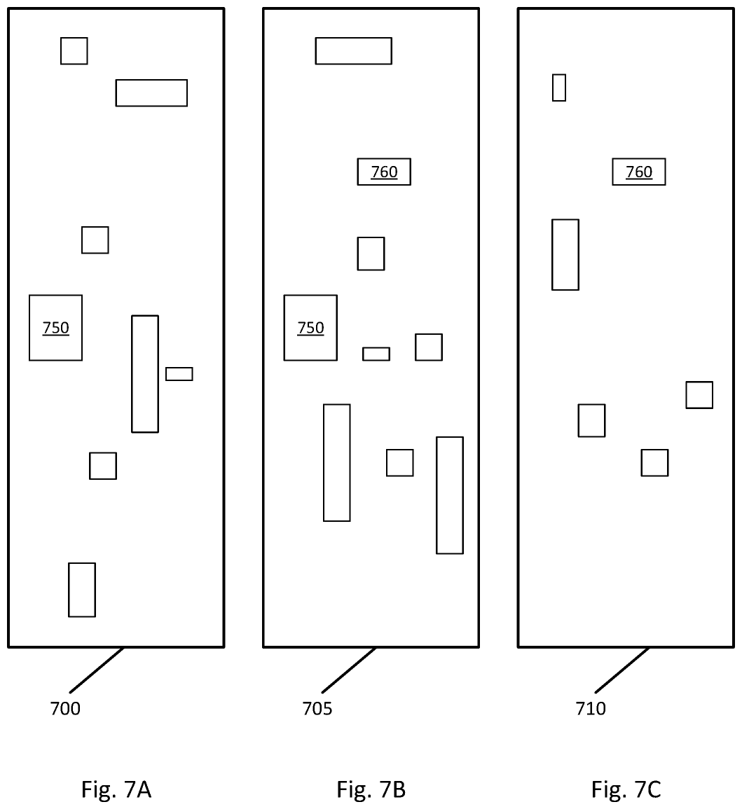

Referring to FIGS. 7A, 7B, and 7C, another example of the application of the selective search engine 30 is shown. FIG. 7A shows a first layer image 700 of the preprocessed area with regions of interest identified by the blocks after application of the graph-based segmentation method. FIG. 7B shows a second layer image 705 of the preprocessed area with regions of interest identified by the blocks after application of the graph-based segmentation method. FIG. 7C shows a second layer image 710 of the preprocessed area with regions of interest identified by the blocks after application of the graph-based segmentation method. In this example, the search area may be defined for regions of interest with significant overlap among at least two of the three levels in the pyramid. Significant overlap may mean substantially identical regions of interest or if the overlap is above a predetermined threshold, such as 95%, 90%, or 85%. Under these conditions, it is to be appreciated that any regions of interest missed on one level may be caught at a different level and sent for further processing. As shown in FIGS. 7A and 7B, the region of interest identified by 750 has appears in two of the three layers. Similarly, the region of interest identified by 760 has appears in a different two of the three layers. Accordingly, both the region of interest 750 and the region of interest 760 will be defined as a search area for the classification engine 35.

In yet another example, the search area may be defined for regions of interest with significant overlap unanimously across all three levels in the pyramid. Significant overlap may mean substantially identical regions of interest or if the overlap is above a predetermined threshold, such as 95%, 90%, or 85%. By using a unanimous correlation across all levels, regions of interested identified by the selective search engine 30 not identified on a level may be excluded and therefore may reduce the number of false positives to be sent to the classification engine 35 even further. Therefore, this may reduce the computational resources to classify the defined search areas.

In other examples where the pyramid representation may have more or less than three levels, another predetermined threshold may be chosen. For example, if five levels of images are generated in the Gaussian pyramid representation, a search area may be defined if there is correspondence between two, three, four, or all of the five layers.

Block 440 involves classifying the search area to provide a binary classification of the local defect. The manner by which the search area is classified the is not particularly limited. In the present example, machine learning models may be used to determine if a local defect is present within a defined search area of the input image. For example, the prediction model may be a support vector machine model or other classifier models such as random forest trees, Naïve Bayes classifiers. Accordingly, the prediction model may classify the search area as either defective or non-defective. In other examples, neural networks, such as convolutional neural networks, or recurrent neural networks may also be used to provide more complicated classifications. In other examples, a rules-based prediction method to analyze the defined search area of the input image may be used.

Various advantages will now become apparent to a person of skill in the art. For example, the system 200 may provide an objective manner for detecting and identifying local defects on output from a printing device. Furthermore, the method may also identify issues with print quality before a human eye is able to make such a determination. In particular, this will increase the accuracy of the analysis leading to improved overall print quality from printing devices.

It should be recognized that features and aspects of the various examples provided above may be combined into further examples that also fall within the scope of the present disclosure.

What is claimed is:

1. An apparatus comprising:
a communication interface to receive an image of output from a printing device;
a memory storage unit connected to the communication interface, the memory storage unit to store the image of the output;
a preprocessing engine to process the image;
a selective search engine to define a search area within the image, wherein the selective search engine defines the search area of the image based on a local defect of unknown size; and
a classification engine in communication with the selective search engine, wherein the classification engine is to classify the search area for identification of the local defect.

2. The apparatus of claim 1, wherein the preprocessing engine reduces halftone effects in the image.

3. The apparatus of claim 2, wherein the preprocessing engine applies a Nasanen filter to reduce the halftone effects.

4. The apparatus of claim 1, wherein the selective search engine uses a pyramid representation to detect the local defect.

5. The apparatus of claim 4, wherein the pyramid representation is a Gaussian pyramid representation.

6. The apparatus of claim 5, wherein the Gaussian pyramid representation includes a first level, a second level and a third level.

7. The apparatus of claim 6, wherein the selective search engine maintains a size of the image across the first level, the second level, and the third level.

8. The apparatus of claim 7, the selective search engine upsamples the image at the first level, the second level, and the third level.

9. The apparatus of claim 1, wherein the classification engine uses a support vector machine model to classify the search area.

10. A method comprising:
receiving an input image of output from a printing device;
preprocessing the input image to descreen the input image to generate a preprocessed image;
defining a search area within the within the preprocessed image based on a local defect of unknown size; and
classifying the search area to provide a binary classification of the local defect.

11. The method of claim 10, wherein the classifying uses a support vector machine model.

12. The method of claim 11, wherein the support vector machine model classifies the search area as defective or non-defective.

13. The method of claim 10, wherein defining the search area involves applying a Gaussian pyramid representation.

14. The method of claim 13, wherein defining the search area involves applying to graph-based segmentation method to a level of the Gaussian pyramid representation.

15. A non-transitory machine-readable storage medium encoded with instructions executable by a processor, the non-transitory machine-readable storage medium comprising:
instructions to receive an input image of output from a printing device;
instructions to preprocess the input image to descreen the input image to generate a preprocessed image;
instructions to apply a Gaussian pyramid representation to the preprocessed image to define a search area based on a local defect of unknown size, wherein the Gaussian pyramid representation generates a first level image, a second level image, and a third level image; and
instructions to classify the search area to provide a binary classification of the local defect.
